(19) United States
(12) Patent Application Publication
(10) Pub. No.: US 2022/0132794 A1
(43) Pub. Date: May 5, 2022

(54) ASYMMETRICAL REFLECTOR HEATER FOR POULTRY AND LIVESTOCK CULTIVATION

(71) Applicant: Enerco Group, Inc., Cleveland, OH (US)

(72) Inventors: Jeff Bunsey, Bay Village, OH (US); Mike Allen, Cleveland, OH (US)

(73) Assignee: Enerco Group, Inc., Cleveland, OH (US)

(21) Appl. No.: 17/515,617

(22) Filed: Nov. 1, 2021

Related U.S. Application Data
(60) Provisional application No. 63/108,525, filed on Nov. 2, 2020.

(51) Int. Cl. A01K 1/00; H05B 3/44

(52) U.S. Cl. CPC A01K 1/0076; H05B 3/44

(57) ABSTRACT

One or more techniques and/or apparatuses are disclosed to provide for the reflection of electromagnetic waves from an infrared heater in an enclosed structure. The infrared heater is placed off-center in the enclosed structure and an asymmetrical reflector disproportionally reflects the electromagnetic waves to the far side of the enclosed structure to evenly heat the enclosed structure. The infrared heater and asymmetrical reflector can be used to evenly heat poultry within the enclosed structure to promote uniform eating and conversion of food to muscle mass.

### CROSS-REFERENCE TO RELATED APPLICATIONS

This application claims priority to U.S. provisional Ser. No. 63/108,525, entitled ASYMMETRICAL REFLECTOR HEATER FOR POULTRY CULTIVATION, filed on Nov. 2, 2020, of which is incorporated herein by reference.

### BACKGROUND

Heating can be an important consideration in poultry and livestock cultivation, and different heating apparatuses can influence different properties of the poultry and livestock as they grow and age from newly birthed to mature animals. Poultry and certain types of livestock are often housed in enclosed structures with controlled conditions, not only to protect the animals from weather, predators, and disease, but also to influence the physical properties of the mature birds. One such controlled condition is the temperature inside the enclosed structure. It is desirous that heating apparatuses evenly distribute heat at specific temperatures, to promote animal uniformity and feed conversion.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein are provided that can be used to help evenly distribute heat in an enclosed structure, where the heating apparatus is positioned off center. In one implementation, a radiant heating apparatus is provided that comprises an electromagnetic wave reflector, the electromagnetic wave reflector having a first side and a second side, wherein the first side and second side are oriented on opposing ends, and the first side is shaped and sized to form a gradual incline, and the second side is shaped and sized to form a steep decline, and together the first side and the second side form an asymmetrical arch. In this implementation, an elongated radiant tube is nested within (e.g., underneath) the electromagnetic wave reflector, and as the elongated radiant tube emits radiant energy, the first side of the electromagnetic wave reflector reflects the radiant energy in a first direction, and the second side of the electromagnetic wave reflector reflects the radiant energy in a second direction. Further, in this implementation, the first direction is farther in distance than the second direction.

In another implementation a radiant heating apparatus is provided that comprises an electromagnetic wave reflector, the electromagnetic wave reflector having a first side and a second side, wherein the first side and second side are oriented on opposing ends, and the first side is shaped and sized to form a first arch with a gradual incline, and the second side is shaped and sized to form a second arch with a steep decline, and together the first side and the second side form two asymmetrical arches. In this implementation, an elongated radiant tube is nested within the electromagnetic wave reflector, and as the elongated radiant tube emits radiant energy, the first side of the electromagnetic wave reflector reflects the radiant energy in a first direction, and the second side of the electromagnetic wave reflector reflects the radiant energy in a second direction. Further, in this implementation, the first direction is farther in distance than the second direction.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1A is a component diagram illustrating one example of structure where one or more portions of one or more systems described herein may be implemented.

FIGS. 1B and 1C are a component diagrams illustrating examples of structures where one or more portions of one or more systems described herein may be implemented.

FIG. 2 is a component diagram illustrating one example of a top view of an exemplary embodiment of an asymmetrical reflector described herein.

FIG. 3 is a component diagram illustrating one example of a cross-sectional view of an asymmetrical reflector described herein.

FIG. 4 is a component diagram illustrating one example of a top view of an exemplary embodiment of at least a portion of another asymmetrical reflector described herein.

FIG. 5 is a component diagram illustrating one example of a cross-sectional view of another asymmetrical reflector described herein.

FIG. 6 is a component diagram illustrating one example of a connection point (e.g., center point) of an exemplary embodiment of an asymmetrical reflector described herein.

FIG. 7 is a component diagram illustrating one example of a top view of a flat pattern of an exemplary embodiment of at least a portion of another asymmetrical reflector described herein.

FIG. 8 is a component diagram illustrating one example of a cross-sectional view of another asymmetrical reflector described herein.

FIG. 9 is a component diagram illustrating one example of another connection point of an exemplary embodiment of an asymmetrical reflector described herein.

FIG. 10 is a component diagram illustrating one example of a top view of an exemplary embodiment of another asymmetrical reflector described herein.

FIG. 11 is a component diagram illustrating one example of a cross-sectional view of another asymmetrical reflector described herein.

FIG. 12 is a component diagram illustrating one example of another example connection point of an exemplary embodiment of an asymmetrical reflector described herein.

FIG. 13 is a component diagram illustrating one example of a top view of an exemplary embodiment of another asymmetrical reflector described herein.

FIG. 14 is a component diagram illustrating one example of a cross-sectional view of another asymmetrical reflector described herein.

FIG. 15 is a component diagram illustrating one example of another example connection point of an exemplary embodiment of an asymmetrical reflector described herein.

FIG. 16 is a component diagram illustrating one example of a top view of an exemplary embodiment of another asymmetrical reflector described herein.

FIG. 17 is a component diagram illustrating one example of a cross-sectional view of another asymmetrical reflector described herein.

FIG. 18 is a component diagram illustrating a hanger for holding a heating apparatus and an exemplary asymmetrical reflector described herein.

FIG. 19 is a component diagram illustrating one example of another hanger for holding a heating apparatus and an exemplary asymmetrical reflector described herein.

FIG. 20 is a component diagram illustrating one example of structure where one or more portions of one or more systems described herein may be implemented.

FIG. 21 is a component diagram illustrating one example of structure where one or more portions of one or more systems described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

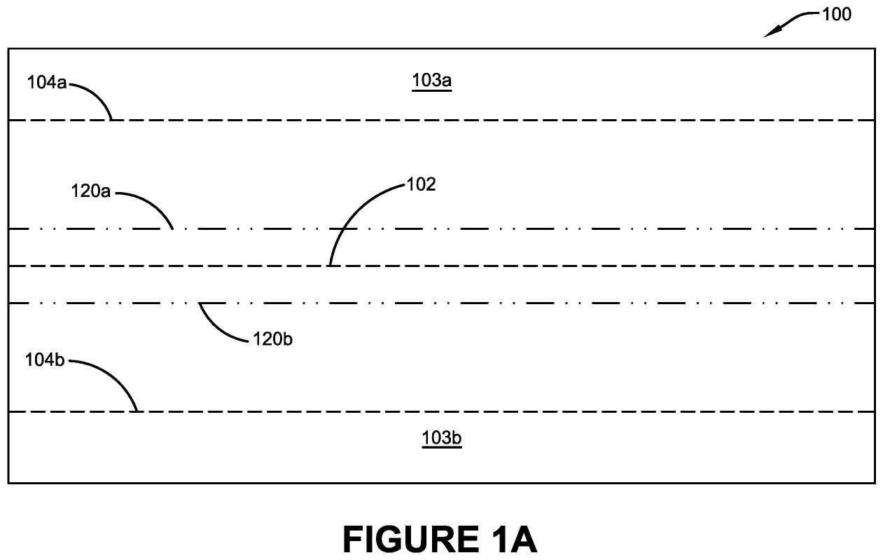

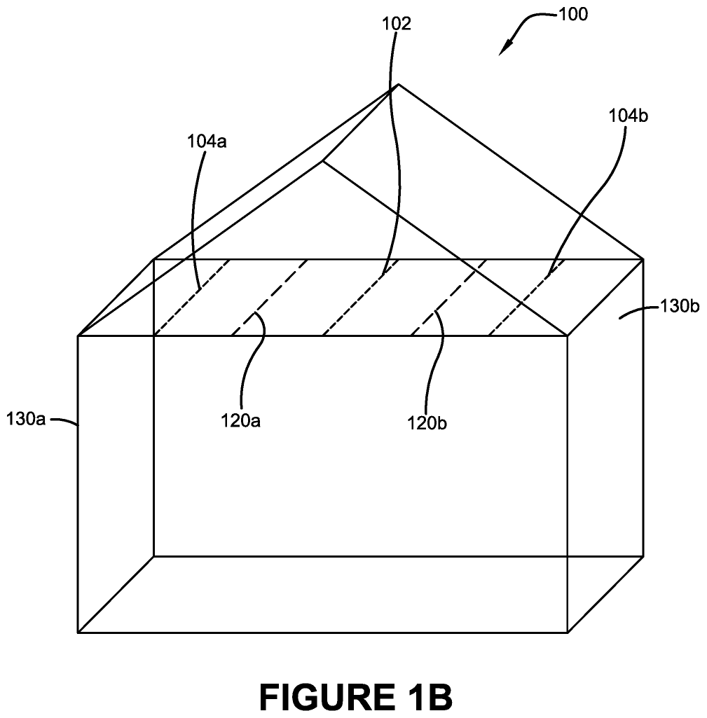

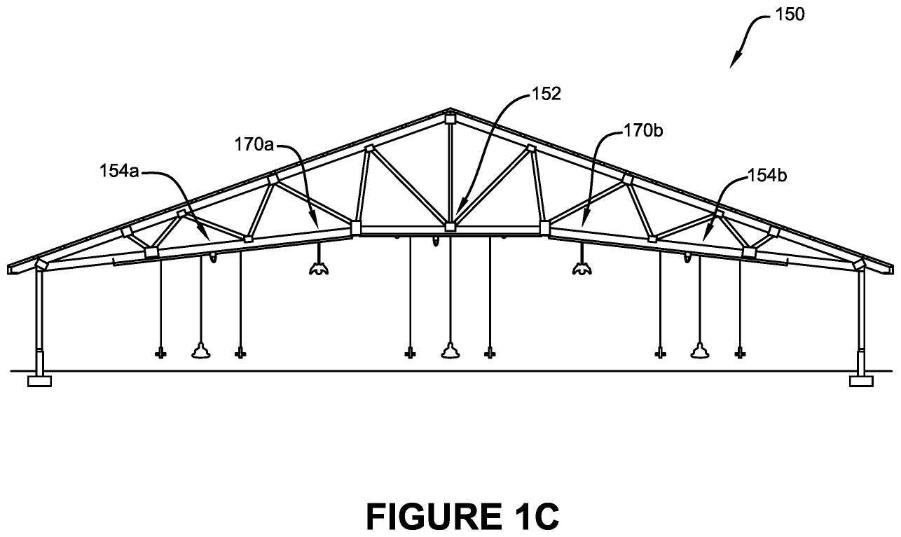

FIGS. 1A and 1B are component diagrams illustrating a plan view and elevation view of at least a portion of a structure 100 where poultry may be housed. As an example, when cultivating poultry inside an enclosed structure 100 (e.g., an elongate building), food and water may be strategically placed within the structure 100 to promote an even distribution of food and water intake among the animal population. That is, for example, food/water placement may be designed to optimize availability to the animals in order to optimize intake by the animals. For example, in an elongate structure one or more food/water distribution stations may be disposed along a centerline 102 of the structure 100, and at outer locations 104a, 104b in respective outer wings 130a, 130b of the enclosed structure 100. An even intake of food and water among the animals may increase the uniformity of the mature animal, resulting in more predictable cultivation sizes and times. For example, as poultry matures from hatchlings to mature birds, the first twenty-eight days of cultivation may influence the physical characteristics of the mature birds, with the muscle mass of the mature bird dependent on the food and water intake, and energy output of the poultry. As an example, the more food and water the hatchlings are able to consume during this time, and the less the hatchlings have to move or compete with other hatchlings for the food and water, the more weight the mature bird may accumulate. Accordingly, an even distribution of hatchlings amongst the food and water sources 102, 104a, 104b may result in a more uniform flock of mature birds, with increased higher mature weight.

Other than the placement of the food and water, environmental conditions within the structure 100 may also have an effect on the weight of mature birds, and the uniformity of the mature animals. Environmental conditions, such as temperature, can be controlled, at least in part, by the placement of one or more heating appliances. As an example, evenly heating the enclosed structure 100 can help promote an even distribution of the poultry population within the enclosed structure 100, thus promoting an even intake of the food and water sources 102, 104a, 104b amongst the animals.

For example, a heating apparatus that unevenly heats areas of the enclosed structure 100 may result in the young animals becoming too hot in one area, which in turn drives them to other areas of the enclosed structure 100; or where the temperature is too low to be comfortable, the young animals may congregate in a warmer location. This type of distribution may result in a greater concentration of young animals congregating in particular food/water distribution locations, favored over others in less desirable locations (e.g. in the less heated areas). As such, in this example, young animals may exert more energy to travel to the more comfortable area of the enclosed structure 100, and/or in competing with other young animals at a food/water distribution location designed for fewer young animals. This can result in extra energy exertion, and/or less food/water uptake, which may not produce desired weight in mature animal (e.g., less than desired food to weight conversion).

To mitigate the uneven heating of the enclosed structure 100, radiant heat, such as infrared heat, may be utilized, which offers an efficient heating (e.g., compared to forced air heat). Radiant heat is transmitted through electromagnetic waves, the electromagnetic waves transforming to heat when intercepted and absorbed by one or more objects. As an example, the floor of (e.g., or other objects in) the enclosed structure 100 can intercept and absorbs the heat, which in turn releases the heat to heat the interior of the building and animals.

Typically, the structures (e.g., 100) that house poultry and certain types of livestock have the food/water distribution system disposed along the centerline 102. Therefore, when the food and water is distributed as shown in FIGS. 1A and 1B, the infrared heating apparatus may need to be placed off-center along the location 120a or 120b. In this example, the offsetting of the heater system at location 120a may result in an uneven distribution of heat, as the electromagnetic waves have a shorter distance to travel to warm the 130a side of the enclosed structure 100, than the distance needed to warm the 130b side of the enclosed structure 100. Because of the distance the electromagnetic waves need to travel to warm the 130b side of the enclosed structure 100, the electromagnetic waves may be less concentrated, and are more likely to encounter other objects prior to reaching the floor, such as air, dust particles and other structural components in the enclosed structure 100, which results in lower temperatures towards the 130b side of the enclosed structure 100. While additional infrared heating apparatuses may be placed on the opposite side of the enclosed structure, such as at 120b, this creates additional cost for materials and energy costs. To mitigate the uneven distribution of heat while using merely one infrared heating apparatus, an asymmetrical reflector may be devised to reflect electromagnetic waves of the infrared heating apparatus disproportionally towards one side of a structure than another side.

FIG. 1C illustrates an elevation plan of another example structure 150 where one or more portions of one or more systems described herein may be implemented. As illustrated, the structure 150 can comprise a poultry barn that house chickens or the like. The structure 150 comprises a central line 152 where central feeding and watering stations may be disposed. Further, a pair of side feeding stations 154a, 154b can be disposed on either side of the central line 152. Therefore, for example, three sets of feeding and watering stations can be disposed in the structure 150. In this way, for example, the poultry can utilize one of the three sets of stations, allowing them to spread out in the structure 150. In some examples, a poultry barn can comprise a pair of heaters 170a, 170b disposed in each wing of the structure.

When utilizing a reflector for an infrared heating apparatus, electromagnetic waves that are directed towards the ceiling from a cylindrical infrared heating apparatus can be reflected downwards. This can result in an increased efficiency of the infrared heating apparatus by directing more of the infrared electromagnetic waves toward desired heating areas/objects. Further, in one aspect, by making the reflector asymmetrical in shape, the electromagnetic waves can be directed/reflected in a desired direction for the desired distribution of heat.

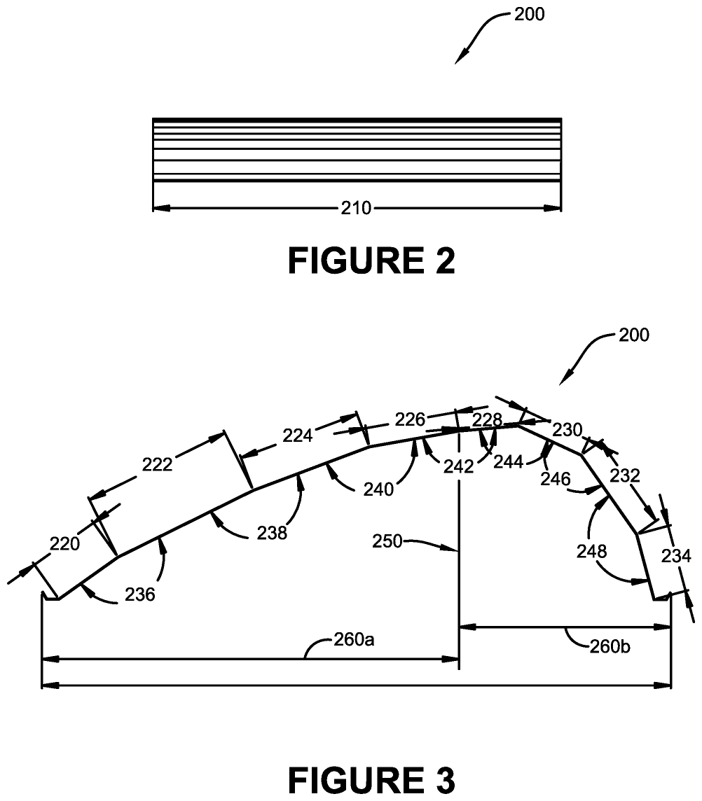

FIGS. 2 and 3 are component diagrams illustrating one implementation of an asymmetrical reflector 200 implementing one or more portions of one or more systems described herein. In this implementation, the asymmetrical reflector 200 may be made of any suitable material for reflecting electromagnetic waves, such as aluminum or an aluminum alloy (e.g., or other metals such as polished steel, stainless steel, or others that provide an effective reflection of IR radiation). The asymmetrical reflector 200 may be made of one or more sheets of the appropriate material. In this implementation, the asymmetrical reflector 200 comprises plurality of flat surfaces, having a length 210, and a plurality of angles (e.g., varying) to reflect electromagnetic waves in varying directions.

For example, a left side 260a of the asymmetrical reflector 200 comprise flat surfaces 220, 222, 224, and 226, which are fixedly connected at angles 236, 238, and 240. In this implementation, the width of respective flat surfaces may range from two to four and a half inches (e.g., 2.13 inches-4.44 inches). For example, flat surface 220 may be 2.13 inches in width, flat surface 222 may be 4.44 inches in width, flat surface 224 may be 3.65 inches in width, and flat surface 226 may be 2.68 inches in width. Further, the respective angles of connection between each flat surface may range from one-hundred and sixty-five to one-hundred and eighty degrees (e.g., 170° to 175°). For example, flat 220 may connect with flat 222 to form angle (e.g., 170°), flat 222 may connect with flat 224 to form angle 238 (e.g., 175°), and flat 224 may connect with flat 226 to form angle 240 (e.g., 170°). It should be appreciated that the left side 260a may have more or less flat surfaces and/or angles.

The width of each flat surface and the angle of connection can determine a slope of incline or decline of each flat surface. Each flat surface is configured to reflect electromagnetic waves in directions and intensities corresponding with the surface area of the flat surface and the slope of the incline or decline of the flat surface. Surfaces with wider widths, and therefore more surface area, may reflect more electromagnetic waves than surfaces with shorter widths. For example, electromagnetic waves reflecting off flat 220 may travel a further distance, but more electromagnetic waves may reflect off flat 222 due to its increased width.

In this implementation, the left side 260a of the asymmetrical reflector 200 can be fixedly connected to a right side 260b of the asymmetrical reflector 200 at angle 242. The angle 242 combines the gradual incline of the slopes of the flat surfaces of the left side 260a, with the steeper decline of the slopes of the flat surfaces of the right side 260b, to form an asymmetrical arch. The angle 242 may be any number of degrees suitable to form the desired asymmetrical arch, such as 175°. The right side 260b of the reflector 200 comprises flat surfaces 228, 230, 232 and 234, that are fixedly connected at a plurality of angles 244, 246, and 248. In this example, the width of respective flat surfaces may range from one and one-half to three inches (e.g., 1.76 inches-2.85 inches.). For example, flat 228 may be 1.76 inches in width, flat 230 may be 2.05 inches in width, flat 232 may be 2.85 inches in width, and flat 234 may be 1.98 inches in width. In this example, the angle of connection between respective flat surfaces may range from about one-hundred and forty-five degrees to one-hundred and sixty-five degrees (e.g., 150° to 160°). For example, flat 228 may connect with flat 230 to form a 150° angle, flat 230 may connect with flat 232 to form a 150° angle, and flat 232 may connect with flat 234 to form a 160° angle. It should be appreciated that the right side 260b may have more or less flat surfaces and or angles.

In another embodiment, the left side 260a of the asymmetrical reflector 200 can be configured to reflect electromagnetic waves at different angles than the right side 260b of the asymmetrical reflector 200. In this embodiment the left side 260a of the asymmetrical reflector 200 is can be wider than the right side 260b, and the slopes and widths of the flat surfaces 220, 222, 224, and 226 of the left side 260a may reflect IR waves at greater distances (e.g., before contact with the floor of a structure in which it is installed) and intensities than the flat surfaces 228, 230, 232, and 234 of the right side 260b.

For example, in one implementation, a tube heater may be used in combination with the reflector 200. In this implementation, the tube heater may be configured to emit infrared radiation from its circumference. Further, in this implementation, the IR tube heater can be disposed along an axis 250 aligned with the location where the left side 260a and right side 260b are joined, at angle 242. In this implementation, the tube heater can run parallel with the length of the reflector 200. In this way, when IR waves are emitted by the tube heater around its circumference, those emitted from the top will impact, and be reflected by, the reflector 200. Due to the asymmetrical design of the reflector 200, those IR waves that impact the left side 260a will be reflected at greater angles than those that impact the right side 260b. In his way, waves reflected by the left side 260a will travel a greater distance before reaching the floor of a structure than those that are reflected from the right side 260b.

In yet another embodiment, a heating apparatus is disposed in proximity to (e.g., nested within, beneath and/or within the respective sides of) the asymmetrical reflector 200. Further, the heating apparatus and asymmetrical reflector 200 can be installed in an enclosed, elongate structure (e.g., 100). As one example, poultry buildings can be a variety of lengths, but are typically longer (e.g., along the centerline 102) than they are wide. In one example, a heating system (e.g., IR tube heat) can be installed along at least a portion of the length of the structure (e.g., at 120a, 120b), along with an asymmetrical reflector, where the distance from the centerline (e.g., 102) to the heating system (e.g., at 120a or 20b) is approximately 4-6 feet.

In one implementation, with reference to FIGS. 1A and 1B, the asymmetrical reflector 200 and heating apparatus are arranged so that the left side 260a is directed toward a far side 130b of the enclosed structure 100, and the right side 260b is directed toward the closest side 130a of the enclosed structure 100. In this embodiment, the heating apparatus and reflector 200, as illustrated, would be installed at location 120b; and if turned around, can be installed at location 120a. Further, a an example, the heating apparatus can emit electromagnetic waves in the form of infrared heat (light) waves that heat the ground and other object to a desired temperature range (e.g., 73° F.-88° F.). T=In this example, to provide even heat for the enclosed structure 100, the left side 260a of the asymmetrical reflector 200 reflects more electromagnetic waves towards the far side 130b of the of the enclosed structure 100, and the right side 260b of the asymmetrical reflector 200 reflects less electromagnetic waves towards the near side 130a of the enclosed structure 100. This can result in the ground and other objects of the enclosed structure 100 having a more uniform temperature range of 73° F.-88° F.

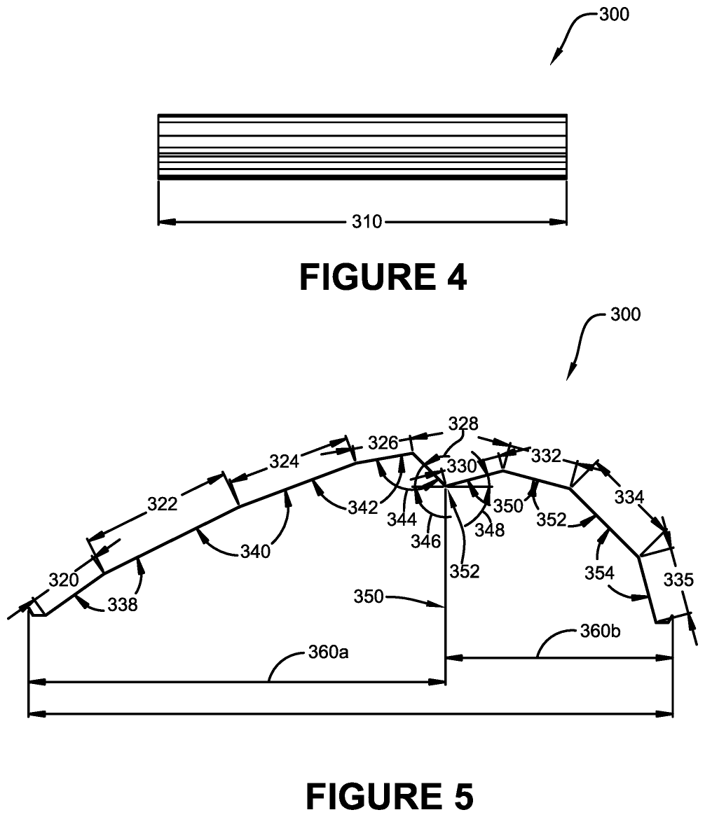

FIGS. 4 and 5 are component diagrams illustrating in another embodiment of an example, asymmetrical reflector 300. In this implementation, the asymmetrical reflector 300 can be made of any suitable material for reflecting electromagnetic waves, such as aluminum. Further, the asymmetrical reflector 300 may be made of one or more sheets of the chosen material. In this implementation, the asymmetrical reflector 300 comprises a plurality of flat surfaces, along a length 310 (e.g., of a desired size to fit the target structure), that are formed at varying angles to reflect electromagnetic waves in one or more desired directions. In this example, the left side 360a of the asymmetrical reflector 300 comprises flat surfaces 320, 322, 324, 326, and 328 that are fixedly connected at angles 338, 340, 342, and 344.

In some implementations, the width of respective flat surfaces may range from about one inch to about 5 inches (e.g., 1.5 inches-4.44 inches). For example, flat 320 may be 2.13 inches in width, flat 322 may be 4.44 inches in width, flat 324 may be 3.65 inches in width, flat 326 may be 1.71 inches in width, and flat 328 may be about 1.5 inches in width. The angle of connection between each flat surface may range from about one-hundred and twenty degrees to about one-hundred and eighty degrees (e.g., 125° to 175°). For example, flat 320 may connect with flat 322 to form a 170° angle, flat 322 may connect with flat 324 to form a 175° angle, flat 324 may connect with flat 326 to form a 170° angle, and flat 326 may connect with flat 328 to form a 125° angle. It should be appreciated that the left side 360a may have more or less flat surfaces and/or angles.

The width of each flat surface and the angle of connection can help determine a slope of incline or decline of each flat surface. For example, each flat surface is configured to reflect electromagnetic waves in directions and intensities corresponding with the surface area of the flat surface and the slope of the incline or decline. Surfaces with longer widths and therefore more surface area may reflect more electromagnetic waves than surfaces with shorter widths. For example, electromagnetic waves reflecting off flat 320 should travel a further distance, but a more electromagnetic waves may be reflected off of flat 322 due to its increased width.

The left side 360a of the asymmetrical reflector 300 is fixedly connected to the right side 360b of the asymmetrical reflector 300 at angle 346. The angle 346 is formed between the flat 328 and a central vertical axis 350 disposed between the left side 360a and the right side 360b. The angle 346 combines the arch of the left side 360a, with the arch of the right side 360b, to form two asymmetrical arches. The angle 346 may be one that is suitable to form the two asymmetrical arches, such as about 125°. Right side 360b is connected to the left side 360a to form an angle 348, which is formed between flat 330 and the central vertical axis 350.

The right side 360b comprises flat surfaces 330, 334, and 336 that are fixedly connected at varying angles 350, 352, and 354. The width of each flat surface may range from about one and one-half inches to about 3 inches (e.g., 1.74 inches-2.86 inches). For example, flat 330 may be 1.74 inches in width, flat 332 may be 2.05 inches in width, flat 334 may be 2.86 inches in width, and flat 336 may be 1.99 inches. in width. In this implementation, the angle of connection between each flat surface may be about 150°. For example, flat 330 may connect with flat 332 to form a 150° angle, flat 332 may connect with flat 334 to form a 150° angle, and flat 324 may connect with flat 326 to form a 150° angle. It should be appreciated that the right side 360b may have more or less flat surfaces and or angles.

In some implementations, the angle 344, 346, 348 and 350, in combination with the width of flat 328 and 330, may determine the downward v-shaped formation of a central reflective portion 352. An effective shape, angle, and depth of the v-shaped central reflective portion 352 may provide for improved distribution of electromagnetic radiation emitted from the IR heater (e.g., disposed below the reflector along the central vertical axis 350. In some implementations, a deep V-shape is utilized, for example, so that when IR radiation emitted from a top of the IR heater and directed up toward the central reflective portion 352, it can be effectively reflected downward and outward. The direction and amount of IR radiation reflected may be based on the angles 344, 346, 348 and 350, in combination with the width of flats 328 and 330, and the distance of the IR heater from the central reflective portion 352. In some implementations, the IR radiation reflected from one or more of the flats (e.g., 328, 330) of the central reflective portion 352 may be directed toward another flat portion of the asymmetrical reflector 300, to be redirected downward. In other implementations, the IR radiation reflected from one or more of the flats (e.g., 328, 330) of the central reflective portion 352 may be directed downward (e.g., toward the floor of the structure).

In another embodiment, the left side 360a of the asymmetrical reflector 300 reflects electromagnetic waves at different angles than the right side 360b of the asymmetrical reflector 300. In this embodiment the left side 360a of the asymmetrical reflector 300 is wider in width than the right side 360b, and the slopes and widths of the flat surfaces 320, 322, 324, 326, and 328 of the left side 360a can reflect light at greater distances and intensities than the flat surfaces 330, 332, 334, and 336 of the right side 360b.

In yet another embodiment, a heating apparatus is disposed beneath (e.g., aligned with axis 350) between the respective sides 360a, 360b of the asymmetrical reflector 300; and the heating apparatus and asymmetrical reflector 300 can be installed in an enclosed structure (e.g., 100), for example, 4-6 feet away from the center 102. In this example, the asymmetrical reflector 300 and heating apparatus can be arranged so that the left side 360a is facing the far side 130b of the enclosed structure 100, and the right side 360b is facing the closest side 130a of the enclosed structure 100. In this embodiment, the heating apparatus emits electromagnetic waves that heat the ground to a desired temperature range (e.g., 73° F.-88° F.). To provide even heat of the enclosed structure 100, the left side 360a of the asymmetrical reflector 300 can be disposed to reflect more electromagnetic waves towards the far side 130b of the of the enclosed structure 100, and the right side 360b of the asymmetrical reflector 300 can be disposed to reflect less electromagnetic waves towards the near side 130a of the enclosed structure 100. This can provide for heating of the enclosed structure with a relatively uniform temperature range.

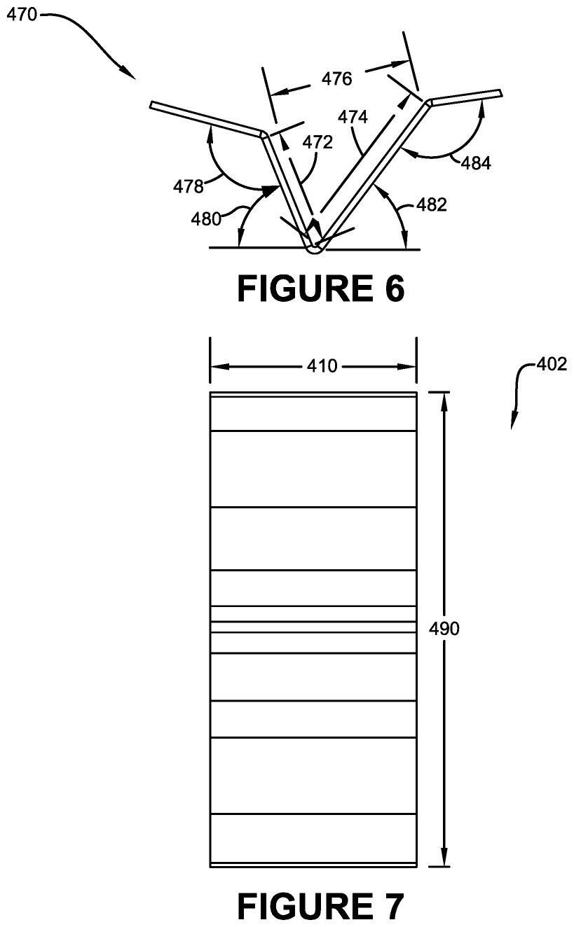

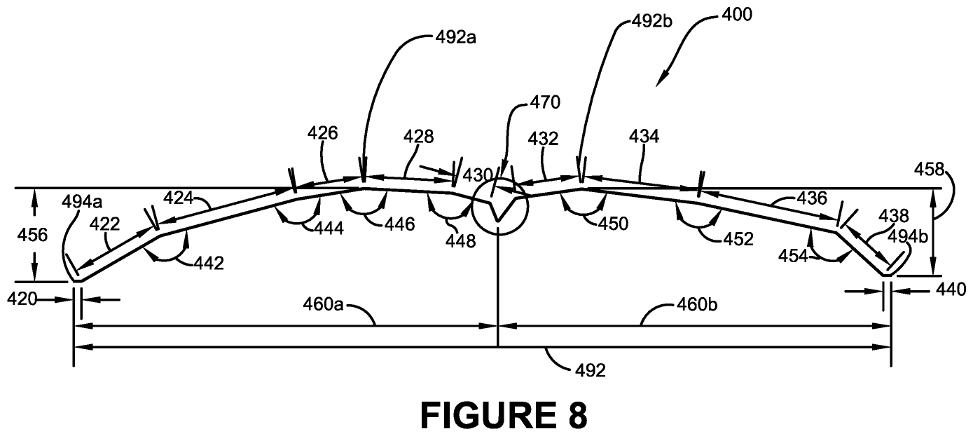

FIGS. 6, 7, and 9 are component diagrams that illustrate one or more portions of another embodiment of an asymmetrical reflector 400, as described herein. FIG. 6 illustrates an example of a center connection point 470 of an asymmetrical reflector 400. FIG. 7 illustrates an example top view of a flat pattern sheet 402 of an asymmetrical reflector 400. That is, for example, the flat pattern sheet 402 comprises flattened material with a width 490 and a length 410, and having scribed pattern lines prior to introducing the bends (angles) to the flat material at the scribed lines. FIG. 8 is a cross-section of a formed reflector 400. In this implementation, the flat sheet. In this implementation, a shallow depth of the respective sides of the asymmetrical reflector is illustrated. As an example, a shallower depth of the respective wings of the asymmetrical reflector 400 can provide for more effective distribution of IR radiation to the desired locations at the ground. In this implementation, the asymmetrical reflector 400 may be formed of any suitable material for reflecting electromagnetic waves, such as aluminum or an aluminum alloy. Further, the asymmetrical reflector 400 may be made of one or more sheets of material. In this implementation, the asymmetrical reflector 400 comprises flat surfaces, over a width 492 (e.g., after bending), and comprising a length 410 (e.g., which may be longer to suit the target installation). As an example, the respective flats can be formed from the flat sheet (FIG. 7) at varying angles to reflect electromagnetic waves in a desired formation and direction.

As an example, the left side 456a of the asymmetrical reflector 400 comprises flat surfaces 420, 422, 424, 426, 428, 430, and 472 that are fixedly connected at a plurality of angles 442, 444, 446, 448, 478, and 480. The width of each flat surface may range from about a ten of an inch to about four and one-half inches in width (e.g., 0.024 inches to 4.44 inches). For example, flat 420 may be about 0.24 inches in width, flat 422 may be 2.83 inches in width, flat 424 may be 4.44 inches in width, flat 426 may be 2.13 inches in width, flat 428 may be 2.76 inches in width, flat 430 may be 1.20 inches in width, and 472 may be 0.57 inches in width. The angle of connection between each flat surface may range from one-hundred and twenty degree to about one-hundred and eighty degrees (e.g., 127° to 174°). For example, flat 422 may connect with flat 424 to form a 165° angle, flat 424 may connect with flat 426 to form a 174° angle, flat 426 may connect with flat 428 to form a 168° angle, flat 428 may connect with flat 430 to form a 168° angle, and flat 430 may connect with flat 472 to form a 127° angle. It should be appreciated that the left side 460a may have more or less flat surfaces and/or angles.

In another embodiment, the width and angles of connection of each flat surface of the left side 456a of the asymmetrical reflector 400 are configured to form an arch with a height distance 456 from the highest point 492a to the lowest point 494a of about three inches (e.g., less than 3 inches). For example, the height distance from the highest point 492a to the lowest point 494a may be 2.94 inches.

The width of each flat surface and the angle of connection can determine the slope of incline or decline of each flat surface. Each flat surface is configured to reflect electromagnetic waves in desired directions and intensities corresponding with the surface area of the flat surface and the slope of the incline or decline of the flat surface. Surfaces with greater widths and therefore more surface area may reflect more electromagnetic waves than surfaces with shorter widths. For example, electromagnetic waves reflecting off 472, will travel the furthest distance, but more electromagnetic waves will be reflected off 424 due to its increased width.

In this implementation, the left side 460a of the asymmetrical reflector 400 is fixedly connected to the right side 460b of the asymmetrical reflector 400 at a central reflector portion 470. The central reflector point 470 couples the arch of the left side 460a, with the arch of the right side 460b, to form two asymmetrical arches. In some implementations, the central reflector portion 470 is disposed immediately above the heater apparatus (e.g., heat tube), to receive IR radiation emitted from the top surface of the heating apparatus. As an example, the heater apparatus can be disposed approximately one-half inch away from the central reflector point 470. In some implementations, the heater apparatus can be disposed between one-tenth of an inch to five inches away from the central reflector point 470. The distance from the heater apparatus to the central reflector point may be determined by sound engineering principles, based on the expected use (e.g., 0.3-2.0 inches). Further, for example the heater apparatus can comprise a heat tube (e.g., a tube IR heater) that comprises a straight tube that run substantially the length of the reflector 400.

In this way, the IR waves are directed away from the central reflector portion 470 to be redirected by the one or more flats of the asymmetric reflector 400. In this implementation, the central reflector portion 470 forms an interior angle of 40° to 80°, and exterior angles, 480 and 482, of 50° to 70°. The two flat surfaces, 472 and 474, comprising the central reflector point 470, can be unequal in width, where the respective angles and flat widths are devised to effectively reflect the IR waves from the top surface of the heating apparatus, for example, to the flats of the reflector 400. In this example, the width 476 of the open V-shape of the central reflector portion 470 may range from about 0.8 to about 1 inch. For example, the central reflector portion 470 may form an interior angle of 59°, and exterior angles 480 and 482, of 68° and 53° respectively. In this example, the central reflector portion 470 is comprised of a flat surface 472 having a width of 0.57 inches, a flat surface 474 having a width of 0.87 inches, and a distance 476 closing the central reflector point 470 of 0.82 inches.

Additionally, in this implementation, the right side 460b of the reflector 400 comprises flat surfaces 474, 432, 434, 436, 438, and 440 that are fixedly connected at a plurality of angles 484, 450, 452, and 454. The width of each flat surface may range from about less than a quarter of an inch to about four and one-half inches (e.g., 0.24 inches to 4.44 inches). For example, flat 474 may be 0.87 inches in width, flat 432 may be 2.07 inches in width, flat 434 may be 3.65 inches in width, flat 436 may be 4.44 inches in width, flat 438 may be 1.97 inches in width, and flat 440 may be 0.24 inches in width. The angle of connection between each flat surface may range from 135°-175°. For example, flat 474 may connect with flat 432 to form a 135° angle, flat 432 may connect with flat 434 to form a 165° angle, flat 434 may connect with flat 436 to form a 175° angle, and flat 436 may connect with flat 438 to form a 150° angle. It should be appreciated that the right side 460b may have more or less flat surfaces and or angles.

In another embodiment, the left side 460a of the asymmetrical reflector 400 reflects electromagnetic waves at different angles than the right side 460b of the asymmetrical reflector 400. In this embodiment the left side 460a of the asymmetrical reflector 400 is greater in width than the right side 460b, and the slopes and widths of the flat surfaces 420, 422, 424, 426, 428, 430, and 472 of the left side 460a reflect light at greater distances and intensities than the flat surfaces 474, 432, 434, 436, 438, and 440 of the right side 460b. For example, the width of the left side 460a may be 13.30 inches and the width of the right side 460b may be 12.33 inches.

In yet another embodiment, a heating apparatus is disposed immediately beneath the central reflector point 470, and within the respective sides 460a, 460b of the asymmetrical reflector 400; and the heating apparatus and asymmetrical reflector 400 can be installed in an enclosed structure 100 off-center from the center 102. The asymmetrical reflector 400 and heating apparatus are arranged so that the left side 460a is facing the far side 130b of the enclosed structure 100, and the right side 460b is facing the closest side 130a of the enclosed structure 100. In this embodiment, the heating apparatus emits electromagnetic waves that heat the objects and the ground to a desired temperature range (e.g., 73° F.-88° F.). To provide even heat of the enclosed structure 100, the left side 460a of the asymmetrical reflector 400 reflects more electromagnetic waves towards the far side 130b of the of the enclosed structure 100, and the right side 460b of the asymmetrical reflector 400 reflects less electromagnetic waves towards the near side 130a of the enclosed structure 100. This results in the ground of the enclosed structure 100 having a uniform temperature range of 73° F.-88° F.

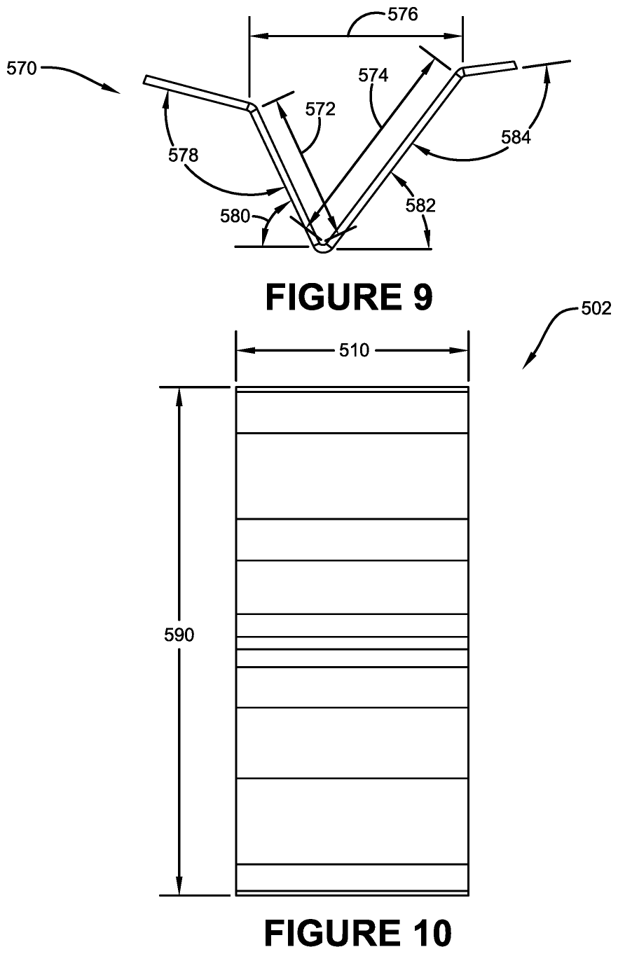

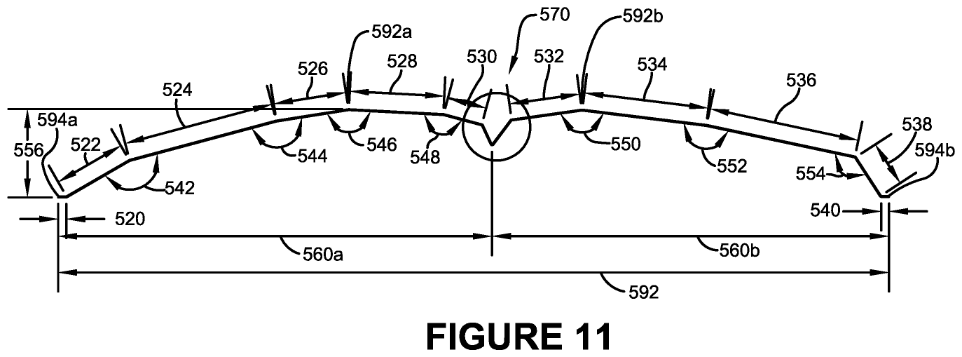

FIGS. 9, 10, and 11 are component diagram illustrating one or more portions of one embodiment another asymmetrical reflector 500, as described herein. Similar to FIGS. 6, 7, and 8, FIG. 9 illustrates a connection point 570 (e.g., centrally disposed) between two side of the wings; FIG. 10 illustrates a patterned flat sheet 502, having a flat width 590, and a length 510; and FIG. 11 illustrates a formed asymmetrical reflector 500, having a formed width 592, when the bends are introduced. The asymmetrical reflector 500 may be constructed from any suitable material for reflecting electromagnetic waves, such as aluminum or an aluminum alloy. The asymmetrical reflector 500 may be constructed of one or more sheets of the suitable material. The asymmetrical reflector 500 comprises flat surfaces, at a width 510, that are bent at varying angles to reflect electromagnetic waves in varying directions. The left side 556a of the asymmetrical reflector 500 comprises flat surfaces 520, 522, 524, 526, 528, 530, and 572 that are fixedly connected at varying angles 542, 544, 546, 548, 578, and 580. The width of each flat surface may range from greater than zero inches to about four and one-half inches (e.g., 0.024 inches-4.44 inches). For example, flat 520 may be 0.24 inches in width, flat 522 may be 2.11 inches in width, flat 524 may be 4.44 inches in width, flat 526 may be 2.13 inches in width, flat 528 may be 2.76 inches in width, flat 530 may be 1.16 inches in width, and flat 572 may be 0.60 inches in width. The angle of connection between each flat surface may range from 130° to 174°. For example, flat 522 may connect with flat 524 to form a 165° angle, flat 524 may connect with flat 526 to form a 174° angle, flat 526 may connect with flat 528 to form a 168° angle, flat 528 may connect with flat 530 to form a 168° angle, and flat 530 may connect with flat 572 to form a 130° angle. It should be appreciated that the left side 560a may have more or less flat surfaces and/or angles.

In another embodiment, the width and angles of connection of each flat surface of the left side 556a of the asymmetrical reflector 500 are configured to form an arch with a height distance 556 from the highest point 592a to the lowest point 594a less than 3 inches. For example, the height distance from the highest point 592a to the lowest point 594a may be 2.58 inches.

The width of each flat surface and the angle of connection can help determine the slope of incline or decline of each flat surface. Each flat surface is configured to reflect electromagnetic waves in directions and intensities corresponding with the surface area of the flat surface and the slope of the incline or decline of the flat surface. Surfaces with longer widths and therefore more surface area may reflect more electromagnetic waves than surfaces with shorter widths. For example, electromagnetic waves reflecting off 572, will travel the furthest distance, but more electromagnetic waves will be reflected off 524 due to its increased width.

The left side 560a of the asymmetrical reflector 500 is fixedly connected to the right side 560b of the asymmetrical reflector 500 at a central reflector portion 570. The central reflector portion 570 couples the arch of the left side 560a, with the arch of the right side 560b, to form two asymmetrical arches. In some implementations, the central reflector portion 570 is disposed immediately above the heater apparatus (e.g., heat tube), to receive IR radiation emitted from the top surface of the heating apparatus. In this way, the IR waves are directed away from the central reflector portion 570 to be redirected by the one or more flats of the asymmetric reflector 500. Ion this implementation, the central reflector portion 570 can form an interior angle of 40°-80°, and exterior angles, 580 and 582, of 50°-70°. The two flat surfaces, 572 and 574, comprising the central reflector portion 570, can be unequal in width, depending on the desired angle of reflection. The width distance 576 of the open top of the V-shape of the central reflector point 570 may range from 0.8-1 inch. For example, the central reflector portion 570 may form an interior angle of 62°, and exterior angles 580 and 582, of 65° and 53° respectively. In this example, the central reflector portion 570 is comprised of a flat surface 572 having a width of 0.60 inches, a flat surface 574 having a width of 0.87 inches, and a distance 576 closing the connection point 570 (e.g., center point)of 0.87 inches.

In this implementation, the right side 560b comprises flat surfaces 574, 532, 534, 536, 538, and 540, which are fixedly connected at a plurality of angles 584, 550, 552, and 554. The width of each flat surface may range from about less than a quarter of an inch to about four and one-half inches (e.g., 0.24 inches-4.44 inches). For example, flat 574 may be 0.87 inches in width, flat 532 may be 2.07 inches in width, flat 534 may be 3.65 inches in width, flat 536 may be 4.44 inches in width, flat 538 may be 1.34 inches in width, and flat 540 may be 0.24 inches in width. The angle of connection between each flat surface may range from 135°-175°. For example, flat 574 may connect with flat 532 to form a 135° angle, flat 532 may connect with flat 534 to form a 165° angle, flat 534 may connect with flat 536 to form a 175° angle, and flat 536 may connect with flat 538 to form a 135° angle. It should be appreciated that the right side 560b may have more or less flat surfaces and or angles.

In another embodiment, the left side 560a of the asymmetrical reflector 500 reflects electromagnetic waves at different angles than the right side 560b of the asymmetrical reflector 500. In this embodiment the left side 560a of the asymmetrical reflector 500 is longer in width than the right side 560b, and the slopes and widths of the flat surfaces 520, 522, 524, 526, 528, 530, and 572 of the left side 560a reflect light at greater distances and intensities than the flat surfaces 574, 532, 534, 536, 538, and 540 of the right side 560b. For example, the width of the left side 560a may be 12.68 inches and the width of the right side 560b may be 11.59 inches.

In yet another embodiment, a heating apparatus is disposed immediately beneath the central reflector point 570, and within the respective sides 560a, 560b of the asymmetrical reflector 500; and the heating apparatus and reflector 500 can be installed in an enclosed structure 100 off center 102. The asymmetrical reflector 500 and heating apparatus can be configure so that the left side 560a is facing the far side 130b of the enclosed structure 100, and the right side 560b is facing the closest side 130a of the enclosed structure 100. In this embodiment, the heating apparatus emits electromagnetic waves that heat the ground to a desired temperature range (e.g., 73° F.-88° F.). To provide even heat of the enclosed structure 100, the left side 560a of the asymmetrical reflector 500 reflects more electromagnetic waves towards the far side 130b of the of the enclosed structure 100, and the right side 560b of the asymmetrical reflector 500 reflects less electromagnetic waves towards the near side 130a of the enclosed structure 100. This results in the ground of the enclosed structure 100 having a uniform, desired temperature range (e.g., 73° F.-88° F.).

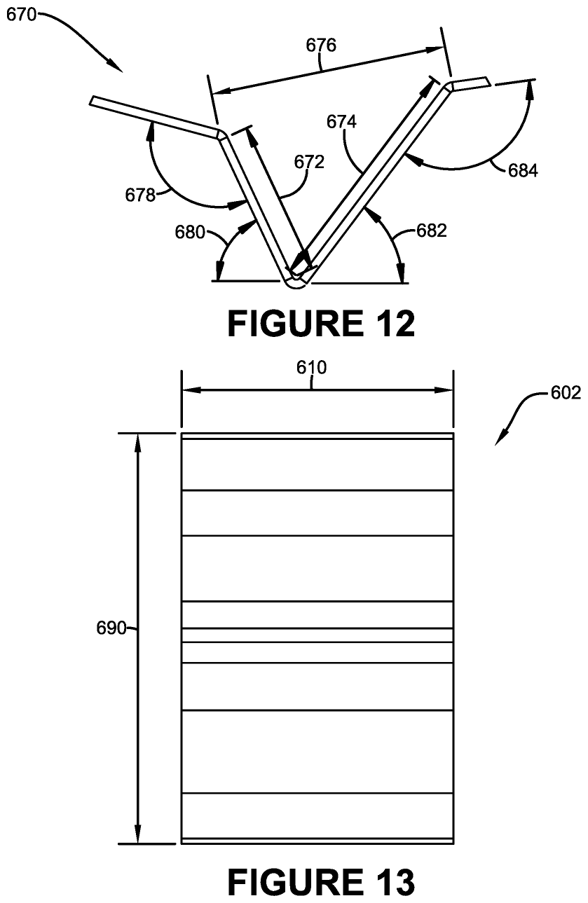

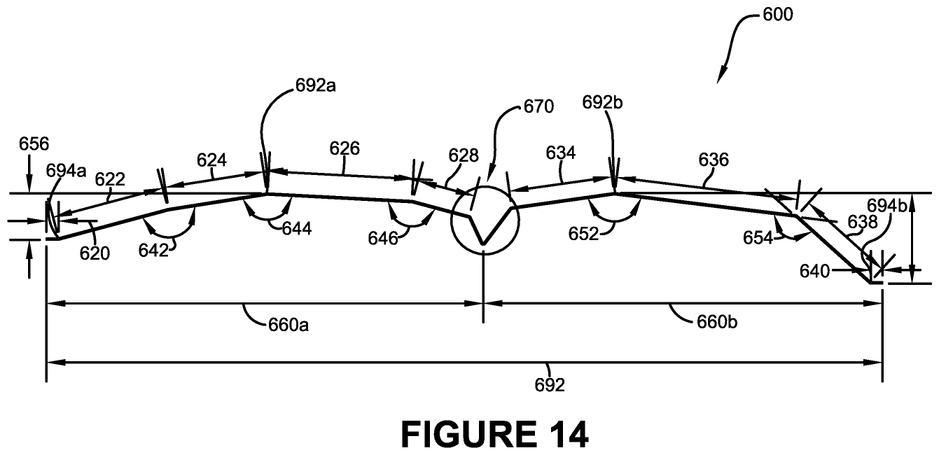

FIGS. 12, 13 and 14, are component diagrams that illustrate one or more portions of another embodiment of an asymmetrical reflector 600, as described herein. Similar to FIGS. 9, 10, and 11, FIG. 12 illustrates a connection point 670 (e.g., centrally disposed) between two side of the wings; FIG. 13 illustrates a patterned flat sheet 602, having a flat width 690, and a length 610; and FIG. 14 illustrates a formed asymmetrical reflector 600, having a formed width 692, when the bends are introduced. In this implementation, the asymmetrical reflector 600 may be constructed of any suitable material for reflecting electromagnetic waves, such as aluminum or an aluminum alloy. The asymmetrical reflector 600 may be made of one or more sheets of suitable material. In this implementation, the asymmetrical reflector 600 comprises flat surfaces, with a formed width 692, and having a length 610 (e.g., which can be of any suitable length) that are formed at a plurality of angles to reflect electromagnetic waves in a desired formation. In this implementation, the left side 656a of the asymmetrical reflector 600 comprises flat surfaces 620, 622, 624, 626, 628, and 672 that are fixedly connected at varying angles 642, 644, 646, 678, and 680. The width of each flat surface may range from a about a ten of an inch to about four and one-half inches in width (e.g., 0.024 inches to 4.44 inches). For example, flat 620 may be 0.24 inches in width, flat 622 may be 2.27 inches in width, flat 624 may be 2.0 inches in width, flat 626 may be 2.90 inches in width, flat 628 may be 1.17 inches in width, and flat 672 may be 0.56 inches in width. The angle of connection between each flat surface may range from 130° to 174°. For example, flat 622 may connect with flat 624 to form a 174° angle, flat 624 may connect with flat 626 to form a 168° angle, flat 626 may connect with flat 628 to form a 168° angle, and flat 630 may connect with flat 672 to form a 130° angle. It should be appreciated that the left side 660a may have more or less flat surfaces and/or angles.

In another embodiment, the width and angles of connection of each flat surface of the left side 656a of the asymmetrical reflector 600 are configured to form an arch with a height distance 656 from the highest point 692a to the lowest point 694a less than 3 inches. For example, the height distance from the highest point 692a to the lowest point 694a may be 0.93 inches.

The width of each flat surface and the angle of connection can help determine the slope of incline or decline of each flat surface. For example, each flat surface is configured to reflect electromagnetic waves in a desired formation of directions and intensities corresponding with the surface area of the flat surface and the slope of the incline or decline of the flat surface. Surfaces with longer widths and therefore more surface area may reflect more electromagnetic waves than surfaces with shorter widths. For example, electromagnetic waves reflecting from flat 672, will travel the furthest distance, but more electromagnetic waves will be reflected from flat 626 due to its increased width.

In this implementation, the left side 660a of the asymmetrical reflector 600 is fixedly connected to the right side 660b of the asymmetrical reflector 600 at a central reflector portion 670. The central reflector portion 670 can couple the arch of the left side 660a, with the arch of the right side 660b, to form two asymmetrical arches. In some implementations, the central reflector portion 670 is disposed immediately above the heater apparatus (e.g., heat tube), to receive IR radiation emitted from the top surface of the heating apparatus. In this way, the IR waves are directed away from the central reflector portion 670 to be redirected by the one or more flats of the asymmetric reflector 600. In this implementation, the central reflector portion 670 forms an interior angle of 40°-80°, and exterior angles, 680 and 682, of 50°-70°. The two flat surfaces, 672 and 674, comprising the central reflector portion 670, are unequal in width, where the respective angles and flat widths are devised to effectively reflect the IR waves from the top surface of the heating apparatus, for example, to the flats of the reflector 600. In this example, the width distance 676 of the open V-shape of the central reflector portion 670 may range from about 0.8-1 inches. For example, the central reflector portion 670 may form an interior angle of 62°, and exterior angles 680 and 682, of 65° and 53° respectively. In this example, the central reflector portion 670 is comprised of a flat surface 672 having a width of 0.56 inches, a flat surface 674 having a width of 0.87 inches, and a distance 676 closing the central reflector portion 670 of 0.85 inches.

In this implementation, the right side 660b comprises flat surfaces 674, 634, 636, 638, and 640 that are fixedly connected at varying angles 684, 652, and 454. The width of each flat surface may range from about less than a quarter of an inch to about four and one-half inches (e.g., 0.24 inches to 4.44 inches). For example, flat 674 may be 0.87 inches in width, flat 634 may be 2.08 inches in width, flat 636 may be 3.65 inches in width, flat 638 may be 1.98 inches in width, and flat 640 may be 0.24 inches in width. The angle of connection between each flat surface may range from 135°-165°. For example, flat 674 may connect with flat 634 to form a 135° angle, flat 634 may connect with flat 636 to form a 165° angle, and flat 636 may connect with flat 638 to form a 145° angle. It should be appreciated that the right side 660b may have more or less flat surfaces and or angles.

In another embodiment, the left side 660a of the asymmetrical reflector 600 can be configured to reflect electromagnetic waves at different angles than the right side 660b of the asymmetrical reflector 600. In this embodiment the left side 660a of the asymmetrical reflector 600 is longer in width than the right side 660b, and the slopes and widths of the flat surfaces 620, 622, 624, 626, 628, and 672 of the left side 660a reflect light at greater distances and intensities than the flat surfaces 674, 634, 636, 638, and 640 of the right side 660b. For example, the width of the left side 660a may be 8.74 inches and the width of the right side 660b may be 7.99 inches.

In yet another embodiment, a heating apparatus is disposed immediately beneath the central reflector point 670, and within the respective sides 660a, 660b of the asymmetrical reflector 600, and can be installed in an enclosed structure 100 off-center from the centerline 102. The asymmetrical reflector 600 and heating apparatus are arranged so that the left side 660a is facing the far side 130b of the enclosed structure 100, and the right side 660b is facing the closest side 130a of the enclosed structure 100. In this embodiment, the heating apparatus emits electromagnetic waves that heat the objects and the ground to a desired temperature range (e.g., 73° F.-88° F.). To provide even heat of the enclosed structure 100, the left side 660a of the asymmetrical reflector 600 reflects more electromagnetic waves towards the far side 130b of the of the enclosed structure 100, and the right side 660b of the asymmetrical reflector 600 reflects less electromagnetic waves towards the near side 130a of the enclosed structure 100. This results in the ground of the enclosed structure 100 having a uniform, desired temperature range of 73° F.-88° F.

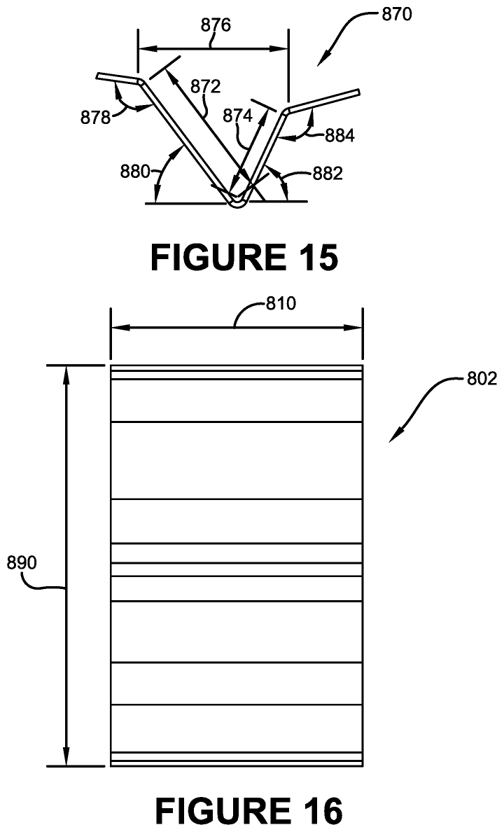

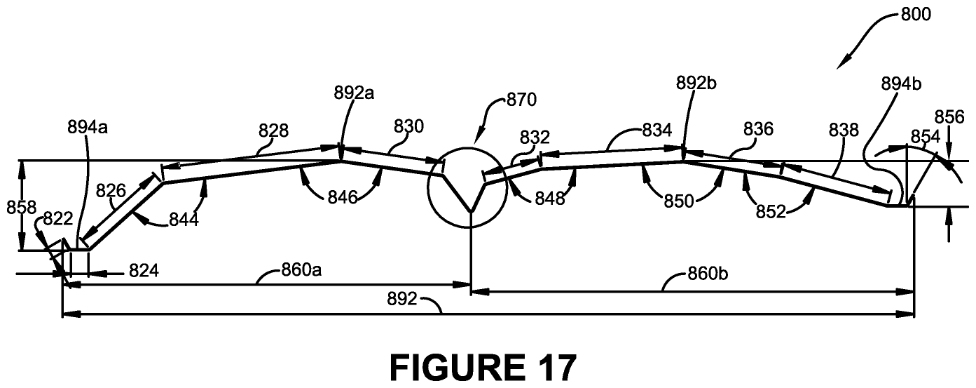

FIGS. 15, 16 and 17, are component diagrams that illustrate one or more portions of another embodiment of an asymmetrical reflector 800, as described herein. Similar to FIGS. 12, 13, and 14, FIG. 15 illustrates a connection point 870 (e.g., centrally disposed) between two side of the wings; FIG. 16 illustrates a patterned flat sheet 802, having a flat width 890, and a length 810; and FIG. 17 illustrates a formed asymmetrical reflector 800, having a formed width 892, when the bends are introduced. In this implementation, the asymmetrical reflector 800 may be constructed of any suitable material for reflecting electromagnetic waves, such as aluminum or an aluminum alloy (e.g., steel, mylar, reflective coated polymer, reflective coated graphite, reflective coated glass/fiberglass, etc.). The asymmetrical reflector 800 may be made of one or more sheets of suitable material, such as layered and/or joined together. In this implementation, the asymmetrical reflector 800 comprises flat surfaces, at a formed width 892, and having a length 810 (e.g., which can be of any suitable length) that are formed at a plurality of angles to reflect electromagnetic waves in a desired formation (e.g., or throw pattern). In this implementation, the left side 860a of the asymmetrical reflector 800 comprises flat surfaces 822, 824, 826, 828, 830, and 872 that are fixedly connected (e.g., formed) at varying angles 844, 846, 878, and 880. In some implementations (e.g., depending on the overall size of the reflector), the width of each flat surface may range from about a tenth of an inch to about three and seven-eighths inches in width (e.g., 0.23 inches to 3.65 inches). For example, flat 822 may be 2.00 inches in width, flat 824 may be 3.65 inches in width, flat 826 may be 2.08 inches in width, and flat 878 may be 0.87 inches in width. The angle of connection between each flat surface may range from 30° to 174°. For example, flat 822 may connect with flat 824 to form a 145° angle, flat 824 may connect with flat 826 to form a 165° angle, and flat 826 may connect with flat 872 to form a 135° angle. It should be appreciated that the left side 860a may have more or less flat surfaces and/or angles than described herein. In general, while the flat surface dimensions are described as examples herein, the dimensions may be increased or decreased depending on the oval size of the reflector. That is, a small reflector may comprise smaller flat dimensions, and a larger reflector may comprise larger flat dimensions.

In another embodiment, the width and angles of connection of each flat surface of the left side 860a of the asymmetrical reflector 800 are configured to form an arch with a height distance 856 from the highest point 892a to the lowest point 894a less than 3 in (e.g., when disposed in operable configuration). For example, the height distance from the highest point 892a to the lowest point 894a may be 1.84 inches.

The combination of the width of each flat surface and the angle between adjacent flat surfaces can help determine a slope of incline or decline of each flat surface, when operably mounted in use. For example, each flat surface is configured to reflect electromagnetic waves in a desired formation of comprising desired directions and intensities in accordance with the surface area of the flat surface and the slope of the incline or decline of the flat surfaces. Surfaces with longer widths and therefore more surface area may reflect more electromagnetic waves than surfaces with shorter widths. For example, electromagnetic waves reflecting from flat 872, can travel the furthest distance, due to the angle of disposition with regard to a horizontal surface, but more electromagnetic waves may be reflected from flat 828 due to its increased width receiving more waves from a source (e.g., heater).

In this implementation, the left side 860a of the asymmetrical reflector 800 is fixedly connected to the right side 860b of the asymmetrical reflector 800 at a central reflector portion 870. The central reflector portion 870 can couple the arch of the left side 860a, with the arch of the right side 860b, to form two asymmetrical arches joined by the central reflector portion 870. That is, for example, in some implementations, the central reflector portion 870 can comprise the center of the reflector 800. In some implementations, the central reflector portion 870 (e.g., the “V”-shaped portion formed by surfaces 872, 874, at angles 880, 882, over distance 876) identifies or forms the center of the reflector 800, from which the respective arches 860a, 860b are formed (e.g., connected), to form the asymmetrical reflector 800.

In some implementations, the central reflector portion 870 can be operably disposed immediately above a heater apparatus (e.g., heat tube or other infrared radiation (IR) device), to receive the IR radiation emitted from the top surface of the heating apparatus. In this way, the IR waves are reflected (e.g., directed away) from the central reflector portion 870 toward the respective arches 860, and can be redirected (e.g., reflected) by the one or more flats of the arches 860 of the asymmetric reflector 800. In this implementation, the central reflector portion 870 forms an interior angle of 40°-80°, and exterior angles, 880 and 882, of 50°-70°. I some implementations, the two flat surfaces, 872 and 874, comprising the central reflector portion 870, are unequal in width, where the respective angles and flat widths are devised to effectively reflect the IR waves from the top surface of the heating apparatus, for example, to the flats of the reflector 800. In this example, the width distance 876 of the open V-shape of the central reflector portion 870 may range from about 0.8-1 inches. For example, the central reflector portion 870 may form an interior angle of 62°, and exterior angles 880 and 882, of 53° and 65° respectively. In this example, the central reflector portion 870 is comprised of a flat surface 872 having a width of 0.87 inches, a flat surface 874 having a width of 0.56 inches, and a distance 876 closing the central reflector portion 870 of 0.92 inches.

In this implementation, the right side 860b comprises flat surfaces 874, 832, 834, 836, 838, 840, and 842 are fixedly connected at varying angles 884, 848, 850, and 852, and 854. The width of each flat surface may range from about less than a quarter of an inch to about two and seven-eighths inches (e.g., 0.23 inches to 2.90 inches). For example, flat 874 may be 0.56 inches in width, flat 832 may be 1.17 inches in width, flat 834 may be 2.90 inches in width, flat 836 may be 2.0 inches in width, and flat 838 may be 2.27 inches in width. The angle of connection between each flat surface may range from 30°-165°. For example, flat 874 may connect with flat 832 to form a 130° angle, flat 832 may connect to flat 834 to form a 168° angle, flat 834 may connect to flat 836 to form a 168° angle, flat 836 may connect with flat 838 to form a 174° angle, and flat 840 may connect with flat 842 to form a 30°. It should be appreciated that the right side 860b may have more or less flat surfaces and or angles.

In another embodiment, the left side 860a of the asymmetrical reflector 800 can be configured to reflect electromagnetic waves at different angles than the right side 860b of the asymmetrical reflector 800. In this embodiment the left side 860a of the asymmetrical reflector 800 is longer in width than the right side 860b, and the slopes and widths of the flat surfaces 822, 824, 826, 828, 830, and 872 of the left side 860a reflect light at greater distances and intensities than the flat surfaces 874, 832, 834, 836, 838, 840, and 842 of the right side 860b. For example, the width of the left side 860a may be 8.36 inches and the width of the right side 860b may be 9.08 inches.

It should be appreciated the dimensions of the respective flat portions, v-shaped section, and angles described herein are merely exemplary implementations. In other implementations, the dimensions (e.g., widths or surface areas) of the flat portions and the v-shaped portion may be larger or smaller depending on the overall size and target use of the reflector. That is, for example, a larger reflector (e.g., 800) may comprise flat portions with greater widths, and different angles; and a smaller reflector may comprise flat portions with smaller widths and alternate angles. Overall, for example, the dimensions of the flat portions, the v-shaped portion, and the angles is configured to result in a ratio or shape that provides a larger IR wave throw pattern from one side (e.g., 860b) that from the other side (e.g., 860a). In this way, for example, when the reflector is operably installed with a IR heater in an off-set manner with respect to a central line of a building, the reflective IR radiation may provide a more desirable coverage of the building even when offset from center.

With reference to FIGS. 1A and 1B, in yet another embodiment, a heating apparatus can be operably (e.g., in use in a building) disposed immediately beneath the central reflector point 870, and within the respective sides 860a, 860b of the asymmetrical reflector 800. As an example, the reflector 800 and heater can be installed in an enclosed structure 100 off-center from the centerline 102. In this example, the asymmetrical reflector 800 and heating apparatus are arranged so that the left side 860a is directed toward (e.g., facing) the near side 130b of the enclosed structure 100, and the right side 860b is directed toward (e.g., facing) the far side 130a of the enclosed structure 100. In this embodiment, the heating apparatus emits electromagnetic waves that heat the objects and the ground to a desired temperature range (e.g., 73° F.-88° F.). To provide even heat of the enclosed structure 100, the right side 860b of the asymmetrical reflector 800 reflects more electromagnetic waves towards the far side 130b of the of the enclosed structure 100, and the right side 860a of the asymmetrical reflector 800 reflects less electromagnetic waves towards the near side 130a of the enclosed structure 100. This results in the ground of the enclosed structure 100 having a more uniform, desired temperature range of 73° F.-88° F., than a heating apparatus with a symmetrical reflector.

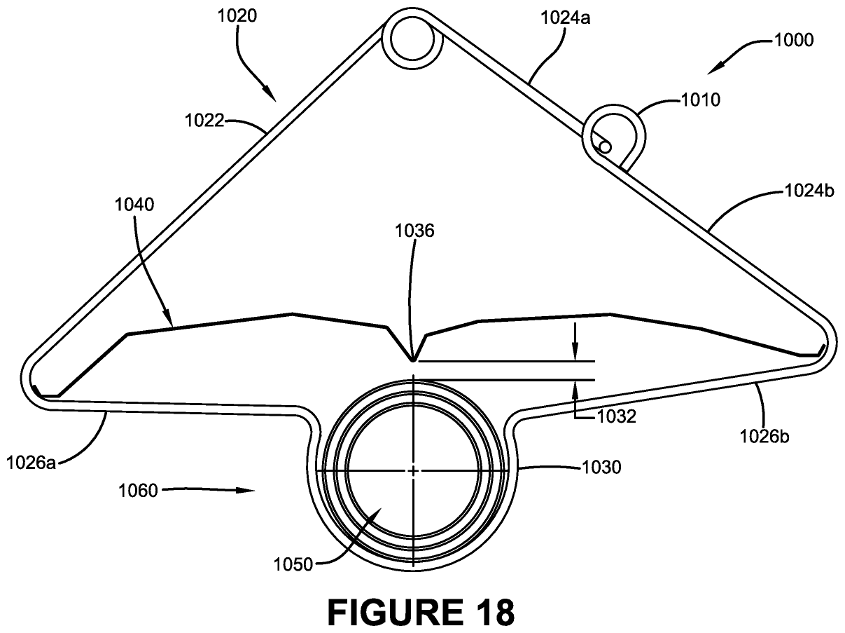

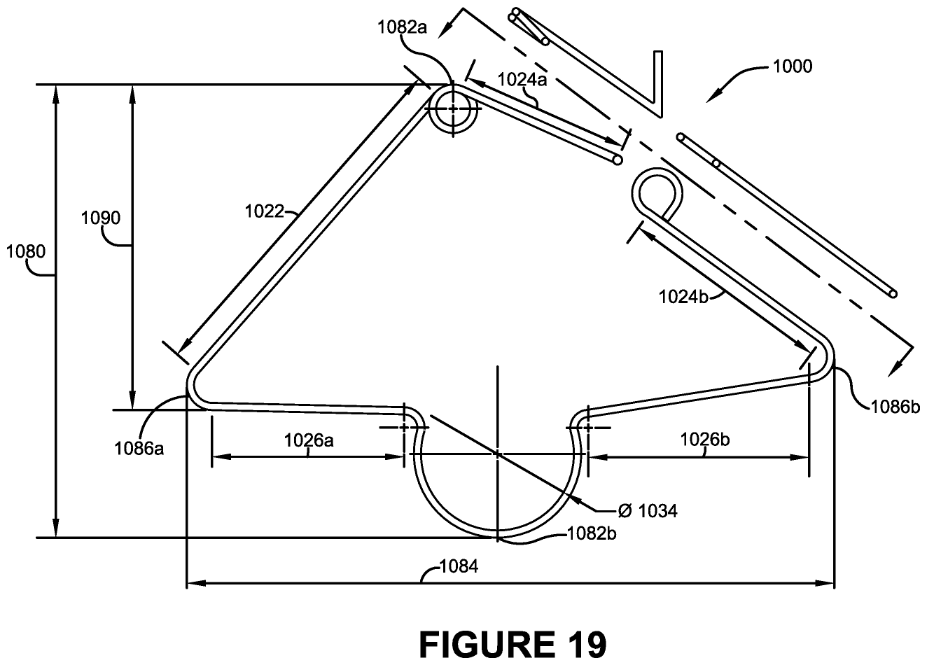

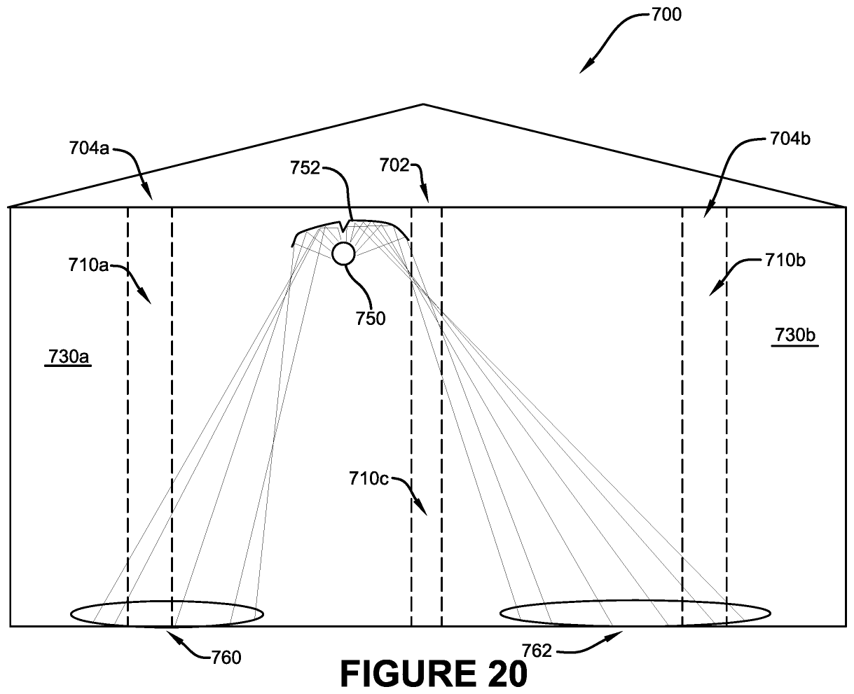

FIGS. 18 and 19 are component diagrams that illustrate a hanger 1000 that can be used to dispose an asymmetrical reflector in an operable position with respect to a heating apparatus 1050, such as above the heater 1050, as disclosed herein. In this implementation, the hanger 1000 may be constructed of any suitable material for holding the asymmetrical reflector and heating device, such as aluminum or an aluminum alloy, steel, other appropriate metals, other appropriate materials. In this implementation, the hanger 1000 may have a desired amount of flexion that allows the hanger 1000 to be opened and closed at the loop 1010, without damaging the hanger 1000 (e.g., at least during installation and/or maintenance). The hanger 1000 may be formed from a one-piece continuous component, or can be formed from multiple components engaged together.

In some implementations, a hanger 100 can be disposed at support locations (e.g., joists) of a structure in which the heater 1050 is disposed, and/or in between support locations. As an example, additional hangers can be coupled to the heater 150 (e.g., and reflector 1040) between support locations to add rigidity to the reflector 1040. That is, for example, at locations closer to the source of heat for the heater (e.g., closer to the flame source), the reflector 1040 may be subjected to potential deformation, and additional hangers can mitigate this deformation. As an example, hangers may be disposed four to five feet apart for some heater styles, or eight to ten feet apart for other styles (e.g., sizes). In some implementations, different spacing can be applied using appropriate engineering principles to meet the specifications of the heather, reflector, and the structure in which it is installed. Further, for example, different gauge sizes of the wire used in the hanger can be implemented accordingly.

In this implementation, the hanger 1000 comprises a triangular-shaped body 1020 with a rounded base 1060 (e.g., partially-annular shaped). The triangular-shaped body 1020 has a left side 1022, a right side comprising a thread portion 1024a and a loop portion 1024b, and two bottom sides 1026a and 1026b. In this implementation, the left side 1022 is a continuous component (e.g., metal wire), in which bend is formed at one end to form the bottom side 1026a. Another bend is formed in the bottom side 1026a to form the rounded base 1030, which comprises an annular-shaped curve. Another bend is formed other side of the rounded base 1030 to form the bottom side 1026b. Another bend is formed on the opposing end of the bottom side 1026b to form the loop of the right side 1024b. At the other end of the left side 1022, the another bend is formed in the one-piece component, which forms the thread portion of the right side 1024a. The thread portion of the right side 1024a is configured to be inserted into the loop portion of the right side 1024b to close the hanger 1000. It should be appreciated that the hanger 1000 may consist of other body and base shapes, such as a hexagonal or pentagonal-shaped body, and a square or rectangular base. It should also be appreciated that the sides may form more or less curves/bends. The purpose of which is to dispose the reflector in an operable position with respect to the heater, such that the resulting IR distribution forms a desired throw pattern in the target building (e.g., an asymmetrical throw pattern of IR for an offset installation).

In some implementations, the triangular body 1020 is shaped and sized to hold an asymmetrical reflector 1040 with respect to a tube heater. As an example, the length of each side of the triangular-shaped body 1020 may range from about five and three-fourths inches to about ten and three-fourths inches (e.g., 5.84 inches to 10.82 inches) (e.g., depending on the size and shape of the reflector and/or the heater, and/or the desired distance of the heater from the reflector). For example, for a hanger 1000 configured to hold a heating apparatus 1040 with a diameter of 4 inches, the left side 1022 may be 10.82 inches in length, the bottom side 1024a may be 5.84 inches in length, the bottom side 1026b may be 6.63 inches in length, the thread of the right side 1024b may be 4.75 inches in length, and the loop of the right side 1024a may be 6.09 inches in length. For a hanger 1000 configured to hold a heating apparatus 1050 with a diameter of 3.5 inches, the left side 1022 may be 10.82 inches in length, the bottom side 1026a may be 6.09 inches in length, the bottom side 1026b may be 6.88 inches in length, the thread of the right side 1024b may be 4.75 inches in length, and the loop of the right side 1024a may be 6.09 inches. in length. For a hanger 1000 configured to hold a heating apparatus 1050 with a diameter of 3.0 inches, the left side 1022 may be 10.82 inches in length, the bottom side 1026a may be 6.34 inches in length, the bottom side 1026b may be 7.13 inches in length, the thread of the right side 1024b may be 4.75 inches in length, and the loop of the right side 1024a may be 6.09 inches in length. When holding an asymmetrical reflector 1040, each side of the asymmetrical reflector 1040 sits on bottom sides of the triangular body 1026a and 1026b.

The angle of each curve of the triangular body 1020 may range from 45° to 107°. For example, the curve from the left side 1022 to the bottom side 1026a may be 50°, the curve from the bottom side 1026b to the loop of the right side 1024b may be 45°, and the curve from the left side 1022 to the thread of the right side 1024a may be 107° when the hanger 1000 is open, and 85° when the hanger 1000 is closed. The loop of the right side 1024a may open at an angle of 55°.

The annular-shaped, rounded base 1030 can be shaped and sized to hold a target heating apparatus 1050, such as an IR tube heater. In some implementations, the heating apparatus 1050 may range in diameter from three inches to four inches (e.g., 3 inches to 4 inches), but can comprise other sizes. For example, the heating apparatus 1050 may be 3 inches in diameter, 3.5 inches in diameter, or 4 inches in diameter. The opening of the rounded base 1030 is sized to approximately fit the diameter of the heating apparatus 1050. For example, when targeted for a heating apparatus with a diameter with 4 inches, the opening of the rounded base 1030 may be about four inches in width (e.g., 4.05±0.125 inches). When targeted for a heating apparatus with a diameter of 3.5 inches, the opening of the rounded base 1030 may be about three and one-half inches in width (e.g., 3.55±0.125 inches). When targeted for a heating apparatus with a diameter of 3.0 inches, the opening of the rounded base 1030 may be about three inches in width (e.g., 3.05±0.125 inches). As an example, the diameter of the annular shape of the rounded base 1034 is sized to fit the diameter of the target heating apparatus 1050. For example, when targeted for a heating apparatus 1050 with a diameter of 4 inches, the diameter 1034 may be about four and one-fourth inches (e.g., 4.25 inches). When targeted for a heating apparatus 1050 with a diameter of 3.5 inches, the partial diameter 1034 may be about three and three-fourths inches (e.g., 3.75 inches). When targeted for a heating apparatus 1050 with a diameter of 3.0 inches, the partial diameter 1034 may be about three and one-fourth inches (e.g., 3.25 inches).

In another embodiment, the triangular-shaped body 1022 and rounded base 1030 hold the asymmetrical reflector 1040 and heating apparatus 1050 in an orientation that enables the asymmetrical reflector 1040 to reflect electromagnetic waves from the heating apparatus 1050. In this embodiment, the heating apparatus 1050 is disposed at a target distance from the asymmetrical reflector 1040, and aligned with the central reflector point 1036. To provide for a desired orientation and distance between the heating apparatus 1050 and the asymmetrical reflector 1040, the bottom sides 1026a and 1026b may be disposed at a slant comprising an appropriate angle from the bottom corners to the rounded base 1030. For example, bottom side 1026a may be slanted at a 1.25° angle, and bottom side 1026b may be slanted at a 8.95° angle. In this implementation, the distance from the heating apparatus 1050 to the central reflector point 1036 may range from about three-eighths of an inch to about seven eighths of an inch (e.g., 0.41 inches to 0.91 inches). For example, a heating apparatus 1050 with a diameter of 4 inches may be 0.41 inches in distance from the central reflector point 1036, a heating apparatus 1050 with a diameter of 3.50 inches may be 0.66 inches in distance from the central reflector point 1036, and a heating apparatus 1050 with a diameter of 3.0 inches may be 0.91 inches in distance from the central reflector point 1036.

In another embodiment, the length and angles of curvature of the triangular body 1022 and rounded base 1030 can be configured to form a hanger 1000 with a height distance 1080 from the highest point 1082a to the lowest point 1082b of less than 14 inches, and a width distance 1084 from the farthest most left point 1086a to the farthest most right point 1086b of about 19 inches (e.g., 18.98±0.13 inches) For example, the height distance 1080 from the highest point 1082a to the lowest point 1082b may be 13.00±0.13 inches for a hanger 1000 holding a heating apparatus 1050 of 4.0 inches in diameter, 12.74±0.13 inches for a hanger 1000 holding a heating apparatus 1050 of 3.5 inches in diameter, or 12.48±0.13 inches. for a hanger 1000 holding a heating apparatus 1050 of 3.0 inches in diameter. In this embodiment, the height distance 1090 from the highest point 1082a to the lowest point of the triangular body 1088 may be 8.13±0.13 inches.

In some implementations, a reflector apparatus can be devised for use with a radiant tube heating system, such as those used in some agricultural buildings, as illustrated in FIGS. 5, 8, 11, 14, and 17,. In these implementations, as illustrated in FIG. 14, as one example, a first wing 660a can comprise a first set of at least three flat sections 622, 624, 626, 628, of differing widths running the length of the first wing 620a. In this implementation, the respective flat sections 622, 624, 626, 628 of the first set can be separated by a bend that disposes adjacent flat section at an angle 642, 644, 646 with respect to each other. Further, a second wing 660b can comprise a second set of at least three flat sections 634, 636, 638, of differing widths running the length of the first wing 620b. In this implementation, the respective flat sections 634, 636, 638 of the first set can be separated by a bend that disposes adjacent flat section at an angle 652, 654 with respect to each other. Additionally, a v-shaped connection point 670 can be disposed between the first wing 660a and the second wing 660b. In this implementation, an inner edge of the first wing 672 is fixedly engaged with a first upper edge of the v-shape 674 of the connection point 670; and, an inner edge of the second wing 676 is fixedly engaged with a second upper edge of the v-shape 678 of the connection point 670.

In this implementation, the first upper edge of the v-shape 672 is disposed lower than the second upper edge of the v-shape 676. However, in alternate implementations, the first upper edge of the v-shape 672 is can be disposed higher than the second upper edge of the v-shape 676, depending on a desired exit angle of infrared energy output by the heater. Further, in this implementation, an outer edge 694a of the first wing 660a is disposed higher than an outer edge 694b of the second wing 660b. However, in alternate implementations the outer edge 694a of the first wing 660a can be disposed lower than the outer edge 694b of the second wing 660b, depending on a desired exit angle of infrared energy output by the heater, and/or a desired throw pattern for the reflector 600.

As an illustrative example, FIG. 20 illustrates one example implementation of a structure 700, in elevation view, where one or more portions of one or more systems described herein may be installed. In this example, the example structure comprises a centerline 702 (e.g., the central point between the outer walls) that runs the length of the structure 700; a left side 730a and a right side 730b. Further, as an example, feeding/watering stations 710a, 710b, 710c may be disposed at the left side, right side, and center respectively. In this example, a heating apparatus 750 (e.g., an IR tube heater) is installed in an offset position from the center line 702, for example, due to the location of the center feeding/water station 702 (e.g., which can have an upper portion that interferes with installation of the heater in the same location). Additionally, an asymmetrical reflector 752 is installed above the heating apparatus 750. As illustrated, the left side (e.g., 860a) of the asymmetrical reflector provides for a left side heating zone 760 that covers the area of the left side feeding/watering station 710a; and the elongated and angled nature of the right side (e.g., 860b) of the reflector 752 provides for a right side heating zone 762 that can cover the right side feeding/water station 710b. As illustrated, in this example, the IR wave throw area of the right side 762 is larger than the IR wave throw area of the left side 760. In this way, for example, heat can be more evenly distributed across the structure, even though the heating apparatus 750 is disposed offset from the centerline 702, such as toward the left side.

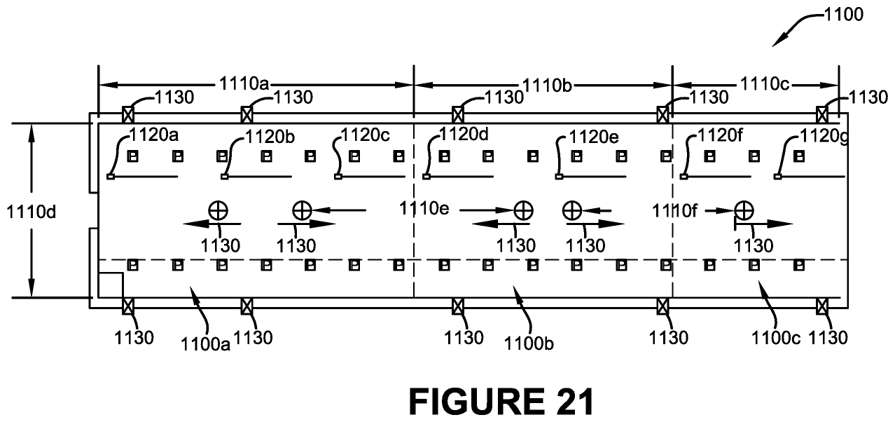

As another illustrative example, FIG. 21 illustrates an example implementation of a structure 1100 from a birds-eye (plan) view, where the structure is separated into three chambers 1100a, 1100b, 1100c, each of which has one or more portions of one or more systems described herein installed. In this implementation, the first chamber 1100a has a first wall 1110a with a length of 128 feet and a second wall 1110d with a length of 70 feet. As an example, testing performed in the first chamber 1110a with three heating apparatuses, 1120a, 1120b, and 1120c, each operating at 100,000 BTU, and installed below an asymmetrical reflector as described herein, provided heating results described below. The first heating apparatus 1120a is disposed on the far side of the chamber, 4 feet from the wall 1110d. The remaining two heating apparatuses, 1120b and 1120c, are disposed 18 feet and 36 feet respectively from the first heating apparatus 1120a. All the heating apparatuses are disposed in a line, 21 feet, 5 inches from the wall 1110d. Fans are disposed at 1130. One and a half hours of running the heating apparatuses, provides data for each asymmetrical heater compiled in Tables 1-2 below, which is representative of the area of the chamber surrounding the heating apparatus divided into the grids. In these tables, the thick black line represents generally where the center of the asymmetrical reflector is disposed, which is offset from center. Tables 3-4 represent the “comfort zones” for animals after running the heating apparatuses for 1 day and 8 days respectively.

Further, in this implementation, the second chamber 1100b has a first wall 1110b with a length of 104 feet and a second wall 1110e with a length of 70 feet. As an example, in the second chamber 1100b two heating apparatuses, 1120d and 1120e are disposed, each operating at 125,000 BTU and installed below an asymmetrical reflector as described herein. The first heating 1120d apparatus is disposed on the far side of the chamber, 4 feet from the wall 1110b. The remaining heating apparatus 1120e are disposed 12 feet from the first heating apparatus 1120d. All the heating apparatuses are disposed in a line, 21 feet, 5 inches from the wall 1120e. Fans are disposed at 1130. One and a half hour of running the heating apparatuses, produces the data for each asymmetrical heater, which is compiled in Tables 5-6 representing the area of the chamber surrounding the heating apparatus, as girds. The thick black line represents generally where the asymmetrical reflector portion is disposed. Tables 7-8 represent the “comfort zones” for animals after running the heating apparatuses for 1 day and 8 days respectively.

Additionally, in this example implementation, the third chamber 1100c has a first wall 1110c with a length of 68 feet and a second wall 1110f with a length of 70 feet. As an example, the third chamber 1100c comprises two heating apparatuses, 1120f and 1120g, each operating at 80,000 BTU and installed below an asymmetrical reflector as described herein. The first heating apparatus 1120f is disposed on the far side of the chamber, 4 feet from the wall 1110c. The remaining heating apparatus 1120g are disposed 16 feet from the first heating apparatus 1120f. All the heating apparatuses are disposed in a line, 21 feet, 5 inches from the wall 1120f. Fans are disposed at 1130. One and a half hours of running the heating apparatuses, produces data for each asymmetrical heater, as compiled in Tables 9-10 representative of the area of the chamber surrounding the heating apparatus, with grids. The thick black line represents generally where the asymmetrical reflector is disposed. Tables 11-12 represent the “comfort zones” for animals after running the heating apparatuses for 1 day and 8 days respectively.

Moreover, the word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter comprises been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure comprises been shown and described with respect to one or more implementations, equivalent alterations and modifications will occur to others skilled in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “comprises,” “having,” “comprises,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A radiant heating apparatus comprising:
an electromagnetic wave reflector, the electromagnetic wave reflector having a first side and a second side, wherein the first side and second side are oriented on opposing ends, and the first side is shaped and sized to form a first arch with a gradual incline, and the second side is shaped and sized to form a second arch with a gradual decline, and together the first side and the second side form two asymmetrical arches; and
an elongated radiant tube, wherein the elongated radiant tube is disposed beneath the electromagnetic wave reflector, and as the elongated radiant tube emits radiant energy, the first side of the electromagnetic wave reflector reflects the radiant energy in a first direction, and the second side of the electromagnetic wave reflector reflects the radiant energy in a second direction, where the first direction is farther in distance than the second direction.

2. The radiant heating apparatus of claim 1, wherein the electromagnetic wave reflector is comprised of aluminum or an aluminum alloy.

3. The radiant heating apparatus of claim 1, wherein the first side and the second side further comprise flat surfaces that are fixedly connected at increasing and then decreasing angles to form the two asymmetrical arches.

4. The radiant heating apparatus of claim 3, wherein the flat surfaces are 0.2 inches to 3.7 inches in width.

5. The radiant heating apparatus of claim 3, wherein the flat surfaces are fixedly connected at an angle of twenty-five degrees to one-hundred and eighty degrees.

6. The radiant heating apparatus of claim 1, wherein the height distance from the highest point to the lowest point of the asymmetrical arches is less than three inches.

7. The radiant heating apparatus of claim 1, wherein the first side and the second side have different width dimensions.

8. The radiant heating apparatus of claim 3, wherein the first side and second side are fixedly connected to form a centrally disposed V-shape.

9. The radiant heating apparatus of claim 1, further comprising a hanger that holds the elongated radiant tube in the nested position within the electromagnetic wave reflector.

10. The radiant heating apparatus of claim 9, wherein the hanger is comprised of a body that holds the electromagnetic wave reflector and a base that holds the elongated radiant tube.

11. The radiant heating apparatus of claim 10, wherein the hanger holds the elongated radiant tube 0.3-2.0 inches from the electromagnetic wave reflector.

12. The radiant heating apparatus of claim 9, wherein two hangers are disposed between three and twelve feet apart on the heating apparatus.

13. The radiant heating apparatus of claim 8, wherein the V-shape of the connection between the first side and the second side reflects radiant energy from the elongated radiant tube from the top surface of the elongated radiant tube to the flat surfaces of the first side and the second side.

14. A method of heating an enclosure comprising:
installing an electromagnetic wave reflector in an offset position from the center line of the enclosure, wherein the asymmetrical electromagnetic wave reflector comprises a first side and a second side, each oriented on opposing ends, and the first side is shaped and sized to form a first arch with a gradual incline, and the second side is shaped and sized to form a second arch with a gradual decline, and together the first side and the second side form two asymmetrical arches;
installing an elongated radiant tube directly beneath the asymmetrical arches, wherein the elongated radiant tube is disposed beneath the electromagnetic wave reflector, and as the elongated radiant tube emits radiant energy, the first side of the electromagnetic wave reflector reflects the radiant energy in a first direction, and the second side of the electromagnetic wave reflector reflects the radiant energy in a second direction, where the first direction is farther in distance than the second direction.

15. The method of claim 15, wherein the electromagnetic wave reflector and the elongated radiant tube are installed using a hanger that holds the elongated radiant tube directly beneath the electromagnetic wave reflector.

16. The method of claim 15, wherein the height distance from the highest point to the lowest point of the asymmetrical arches is less than three inches.

17. The method of claim 15, wherein the first side and the second side further comprise flat surfaces that are fixedly connected at increasing and then decreasing angles to form the two asymmetrical arches, and wherein the connection of the first side and the second side form a V-shape.

18. The method of claim 18, wherein the V-shape of the connection between the first side and the second side reflects radiant energy from the elongated radiant tube from the top surface of the elongated radiant tube to the flat surfaces of the first side and the second side.

19. The method of claim 19, wherein the ground of the enclosure is heated to a uniform temperature.

20. A reflector apparatus for use in a radiant tube heating system, comprising:
a first wing comprising a first set of at least three flat sections of differing widths running the length of the first wing, the respective flat sections of the first set separated by a bend that disposes adjacent flat section at an angle with respect to each other;
a second wing comprising a second set of at least three flat sections of differing widths running the length of the second wing, the respective flat sections of the second set separated by a bend that disposes adjacent flat section at an angle with respect to each other; and
a v-shaped connection point disposed between the first wing and the second wing, wherein an inner edge of the first wing is fixedly engaged with a first upper edge of the V-shape of the connection point, and an inner edge of the second wing is fixedly engaged with a second upper edge of the V-shape of the connection point, and wherein the first upper edge of the V-shape is disposed lower that the second upper edge of the V-shape;
wherein an outer edge of the first wing is disposed higher than an outer edge of the second wing.
